(19) United States
(12) Patent Application Publication
(10) Pub. No.: US 2024/0221227 A1
(43) Pub. Date: Jul. 4, 2024

(54) BLOCK TO BURST CONVERTER

(71) Applicant: GM Cruise Holdings LLC, San Francisco, CA (US)

(72) Inventors: Henry Edward Styles, Menlo Park, CA (US); A N Shanthi Prasad, Cupertino, CA (US); Alpesh Oza, San Jose, CA (US); Michael Bautista, San Francisco, CA (US); Shanmugam Somasundaram Ramanathan, San Jose, CA (US)

(73) Assignee: GM Cruise Holdings LLC, San Francisco, CA (US)

(21) Appl. No.: 18/150,085

(22) Filed: Jan. 4, 2023

(51) Int. Cl. G06T 9/00; G06T 1/60

(52) U.S. Cl. CPC G06T 9/00; G06T 1/60

(57) ABSTRACT

Systems and methods for converting images, such as JPEG images. Decoded image data is produced in block format having minimum coded units (MCUs). The blocks each include a square of pixels and are stored in linear format in memory. A block to burst converter is provided that receives a set of image blocks, stores partial rows of a frame locally, and then writes out each partial row in a burst of raster blocks. The systems and methods provided herein reduce local memory use by orders of magnitude while also reducing system latency.

### BACKGROUND

### 1. Technical Field

The present disclosure generally relates to imaging devices for vehicles and, more specifically, to decoding image data.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles. When driving around, autonomous vehicles, like other vehicles, can drive over road debris that can damage the vehicle tires.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an autonomous vehicle having a block to burst converter 106 for converting and storing image data, according to some examples of the present disclosure;

FIG. 2 illustrates an example encoded image including multiple image blocks, according to some examples of the present disclosure;

FIG. 3 illustrates a simplified block diagram of a system for decoding and storing image blocks, according to some examples of the present disclosure;

FIG. 4 illustrates a diagram of decoding an encoded image and storing the decoded image in memory, according to some examples of the present disclosure;

FIG. 5 is a block diagram illustrating a system for block to burst conversion, according to some examples of the present disclosure;

FIG. 6 is a flow chart illustrating a method for block to burst conversion, according to some examples of the present disclosure;

FIG. 7 illustrates an example system environment that can be used to facilitate autonomous vehicle (AV) dispatch and operations, according to some aspects of the disclosed technology; and

FIG. 8 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview

Systems and methods are provided for converting images from block to raster format. Encoded image data is decoded in block format having minimum coded units (MCUs). The blocks each include a square of pixels (e.g., 8 pixels×8 scan lines) and are stored in linear format in memory. A converter block typically stores complete rows of a frame locally and then writes out each row. However, a complete row of a frame is the entire width of the image and storing complete rows results in excessive memory use for the conversion block. The systems and methods provided herein reduce local memory use by orders of magnitude.

In some examples, images are encoded in JPEG format. An image encoded in JPEG format is stored in blocks of pixels. A JPEG decoder decodes a set of blocks of the JPEG data at a time, and produces MCUs, which are blocks of pixels (e.g., 8 pixels×8 scan lines). The block to burst converter disclosed herein converts an input stream of MCU blocks into an output stream of raster blocks, where a raster block includes pixel data from the first pixel row (scanline) of multiple sequential image blocks, then pixel data from the second pixel row (scanline) of multiple sequential image blocks, then pixel data from the third pixel row (scanline) of multiple sequential image blocks, and so on. According to various implementations, systems and methods are provided herein to convert the image blocks using a subset of an image block row. The subset of the row of image blocks are written to a buffer, such as a Static Random Access Memory (SRAM), on a chip. The pixels in the image blocks in SRAM are processed by a DMA engine, which writes the decoded raster order image data to Dynamic Random Access Memory (DRAM) row by row, such that the first pixel row of each of the subset of image blocks in SRAM is written to DRAM in one burst, then the second pixel row of each of the subset of image blocks in SRAM is written to DRAM in one burst, then the third pixel row, until all the scanlines (pixel rows) in the image blocks have been written to DRAM. In this manner, the subsets of image blocks are saved to the DRAM pixel row-by-pixel row, in raster block format, representing rectangular blocks of the JPEG image. In some implementations, the block to burst converter discussed herein converts images that are decoded from other formats.

According to various implementations, converting the image to raster format using subsets of image blocks enables the image to be converted using a much smaller buffer. For example, a 64 kilobyte or smaller buffer can be used for image conversion as compared to previous solutions that required a buffer of 2 megabytes or larger. The smaller buffer saves space on the chip. Additionally, converting the image using subsets of image blocks enables other processes to access the cache between image block conversions, reducing overall latency of the chip. In a vehicle that is continuously recording high resolution images from multiple cameras (e.g., twelve or more cameras), the benefits of implementing a more efficient system, such as the block to burst converter discussed herein, are realized many times over.

### Example Vehicle for Block to Burst Converter

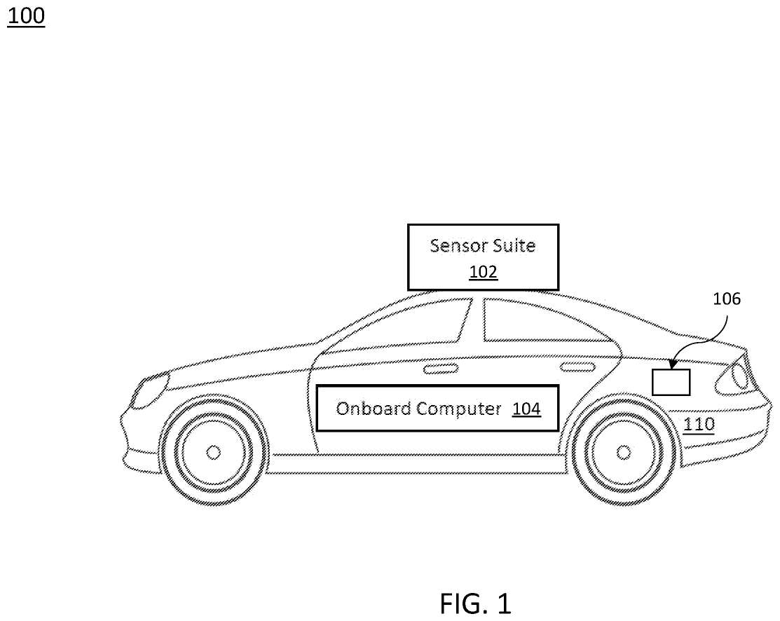

FIG. 1 illustrates an autonomous vehicle 110 having a block to burst converter 106 for converting and storing image data, according to some examples of the present disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. In some examples, the autonomous vehicle 110 can connect with a central computer to download vehicle updates, maps, and other vehicle data. The autonomous vehicle 110 includes a block to burst converter 106 for converting image data recorded by vehicle cameras, such as vehicle image sensors in the sensor suite 102. In some examples, the autonomous vehicle 110 includes multiple image sensors, and the block to burst converter 106 enables quick conversion of image data from each of the image sensors using a small amount of memory, such as 64 bytes of memory per image sensor. In some examples, vehicle cameras record image data, encode the image data, transmit the encoded image data to a decoder, and decoded image blocks (e.g., MCUs) are transmitted to the block to burst converter 106.

The sensor suite 102 includes localization and driving sensors. For example, the sensor suite 102 may include one or more of photodetectors, cameras, radio detection and ranging (RADAR), sound navigation and ranging (SONAR), LIDAR, Global Positioning System (GPS), inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment. In particular, the sensor suite 102 can be used to identify information and determine various factors regarding an autonomous vehicle's environment. In some examples, data from the sensor suite 102 can be used to update a map with information used to develop layers with waypoints identifying various detected items, such as areas with high quantities of road debris, and/or areas with metal infrastructure. Additionally, sensor suite 102 data can provide localized traffic information, ongoing roadwork information, and current road condition information. In this way, sensor suite 102 data from many autonomous vehicles can continually provide feedback to the mapping system and the high fidelity map can be updated as more and more information is gathered.

In various examples, the sensor suite 102 includes cameras implemented using high resolution imagers with fixed mounting and field of view. In further examples, the sensor suite 102 includes LIDARs implemented using scanning LIDARs. Scanning LIDARs have a dynamically configurable field of view that provides a point cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some examples, the onboard computer 104 checks for vehicle updates from a central computer or other secure access point. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the interior sensors can be used to detect passengers inside the vehicle. Image data from the various cameras is transmitted to the block to burst converter 106 for conversion to raster order image data. In some examples, the onboard computer 104 processes the converted images. Additionally, based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, a bicycle, a scooter, a tractor, a lawn mower, a commercial vehicle, an airport vehicle, or a utility vehicle. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

### Example Image for Block to Burst Converter

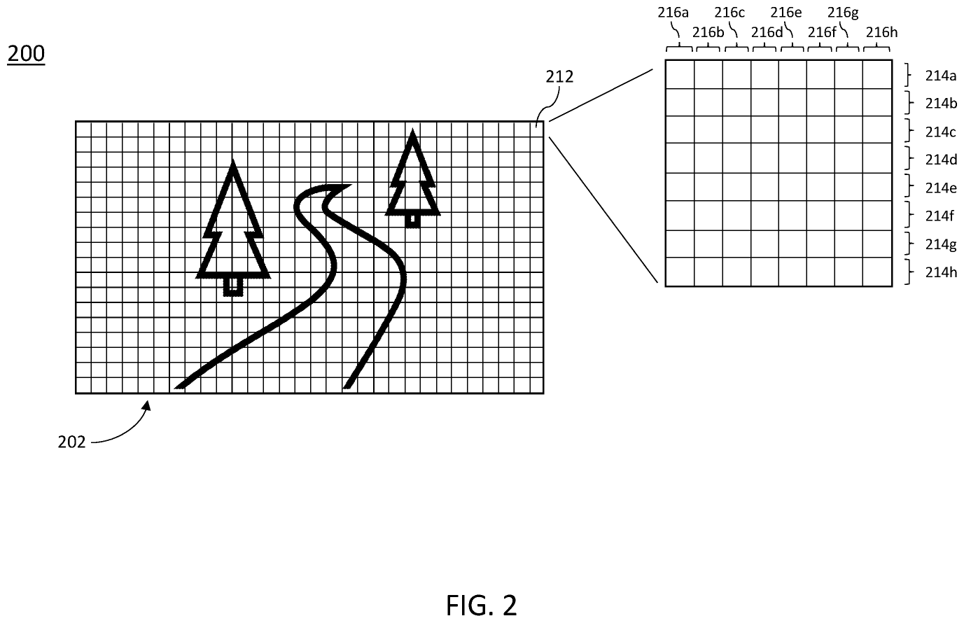

FIG. 2 illustrates an example encoded image 202 including multiple image blocks 212, according to some examples of the present invention. Each image block 212 includes a block of x-by-y pixels of image data. In one example, an image block 212 is an 8 pixel-by-8 pixel square of image data. As shown in FIG. 2, each image block 212 includes eight rows 214a-214h of pixels, each row having eight pixels. Similarly, each image block 212 includes eight columns 216a-216h of pixels, each column having eight pixels. In some examples, each image block 212 is encoded to create an encoded version of the image 202, and the encoded image blocks are decoded to MCUs before transmission to the block-to-burst converter.

Vehicles can include many imagers continuously recording image data. In one example, a vehicle includes twelve cameras, each recording thirty images per second. In other examples, a vehicle includes more than twelve cameras or less than twelve cameras. In some examples, each vehicle camera encodes image sensor data in a compressed format. The large amount of image data is transferred from each vehicle camera to vehicle onboard memory.

Traditional methods of transferring the image data require a large cache or SRAM for each camera in order to convert the image data. In particular, a typical block to raster converter outputs one raster scan line at a time. The raster format streams pixel data sequentially from the top-left of an image to the bottom-right of the image. Thus, at least an entire row of encoded image blocks (representing the entire width of the image) is decoded at a time. The decoded data is stored in a buffer (e.g., a SRAM) before being written to memory (e.g., DRAM). Thus, if an image is 4,000 pixels wide, and an image block is 8×8 pixels, 500 image blocks are loaded to the buffer, and thus a very large buffer is required. A first row of each block (e.g., a first scan line of the image) is written from the buffer to memory (e.g., DRAM), then a second row of each block (e.g., a second scan line of the image), and so on, until the pixels are read for each of the eight rows. The data is saved in memory (e.g., DRAM) one scan line (i.e., one entire row of pixels) at a time.

A large buffer (or cache) is used to convert the image data since a large amount of data is processed at a time before being written to DRAM. However, this requires a large buffer (e.g., SRAM), which uses a large area of a chip. Since a vehicle typically has multiple cameras, and a large buffer is used for each camera, decreasing the buffer size used for conversion to raster order decreases the area of the chip used for the buffer. Additionally, dividing the image into smaller bursts of data for conversion to raster order reduces the latency by breaking long strings of writes into shorter strings of writes. Other operations accessing the same memory will also have reduced latency as the other operations will be able to access the memory more frequently (between shorter bursts of image data writes). In some examples, traditional conversion systems require two megabytes of cache memory (e.g., SRAM). The systems and methods provided herein allow for conversion of images using significantly less memory, for example 64 kilobytes of cache memory (buffer).

In some examples, the encoded images are JPEG images. JPEG images are images compressed with JPEG compression, a method of lossy compression. A JPEG image is encoded in image blocks, where a JPEG image block is an array of pixel component data for eight pixels and eight scan lines (8 pixels per scan line). Monochrome images have a single pixel component Y, wherein Y represents luminance or gray. Color images have three pixel components: Y (luminance, gray), U (blue), and V (red). A JPEG image block contains a single pixel component. Thus, a JPEG stream can be interleaved into units called MCUs, where each MCU includes JPEG image blocks for each pixel component. The number of JPEG image blocks in a MCU depends on the image format (monochrome vs. color) and on the number of pixel components. In various examples, a block to burst converter as discussed herein receives input that is MCU aligned, wherein the size of the MCU is dependent on image format and varies between one and six JPEG blocks. In some examples, the output of the block to burst converter is MCU aligned in size, but is not in MCU format. In various examples, the block to burst converter can be used to convert both interleaved and non-interleaved input streams.

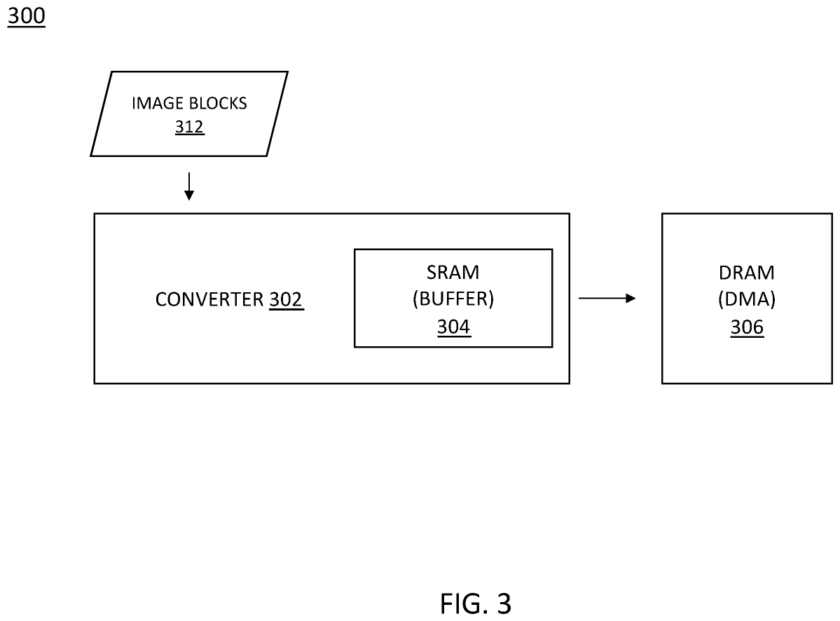

FIG. 3 illustrates a simplified block diagram 300 of a system for converting and storing image blocks, according to some examples of the present disclosure. The image blocks 312 can be transferred to the converter 302. In some examples, the image blocks 312 are decoded image blocks from vehicle cameras. The converter 302 receives a set of image blocks 312. The converter 302 stores a selected number of adjacent MCU image blocks in a buffer 304. The pixels of the MCU image blocks are stored in raster order in the buffer 304 while additional image blocks 312 are converted. The pixels of the MCU image blocks are written into different addresses in the buffer 304 to simplify the read side when sending data from the buffer 304 to the DMA for writing to the DRAM 306. In one example, the buffer 304 is sized to hold about twelve image blocks. In one example, the buffer 304 holds one row of pixels from the converted block of images at a time. In another example, the buffer 304 holds the pixel data for each of the rows of the image blocks 312 in raster order. In some examples, the buffer 304 is 64 bytes, 144 bytes, 288 bytes, 576 bytes, 1152 bytes, 2304 bytes, or 3456 bytes. In some examples, the buffer is an error correction code (ECC) memory. In some examples, the buffer is a non-ECC memory. In some examples, a double buffer is used. The image data from the buffer 304 is received by a DMA engine which writes the converted image data out to DRAM. In some examples, a DMA packet size is 144 bytes. In some implementations, the burst of data from DMA to DRAM includes eights bursts or less than eight bursts. Once the converter stores a selected amount of converted image data (pixel data) in the buffer 304, the block of decoded data from the buffer is written to memory (DRAM 306) in one contiguous memory write (also referred to herein as a “burst”).

In some examples, the buffer 304 is a SRAM buffer. In some examples, the SRAM buffer is configured to hold about eight blocks of data or about twelve image blocks of data, and the SRAM buffer can be configured to hold about 32 bytes, 64 bytes, 128 bytes, or 256 bytes of data. In some examples, the subset of the row of image blocks written to SRAM includes less than half of a row of image blocks. An encoded image block represents an 8 pixel-by-8 pixel portion of the image.

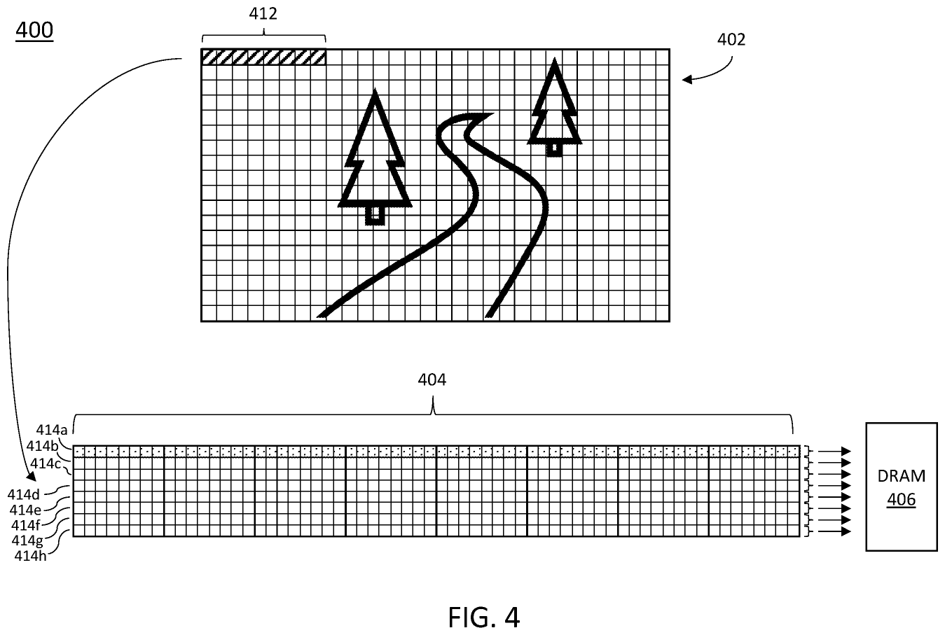

FIG. 4 illustrates a diagram 400 of decoding an encoded image and storing the decoded image in memory, according to some examples of the present disclosure. The image 402 is encoded into multiple image blocks. A block to burst converter reads a first set of image blocks 412. In some examples, for color images, each pixel is represented by multiple image blocks.

As shown at the bottom of FIG. 4, the first set of image blocks include eight image blocks, and each image block includes eight raster lines of eight pixels. The eight adjacent image blocks are stored in a buffer 404. In some examples, the pixels of the image blocks are stored in raster order in the buffer 404. In some examples, the buffer 404 is an SRAM buffer. The image blocks are converted into raster blocks by reading out one raster line 414a-414h at a time to a memory 406. In some examples, the memory 406 is a DRAM memory. Thus, the first raster line 414a is output to the memory 406, then the second raster line 414b is output to the memory 406, and so on for the remaining raster lines 414c-414h. In some examples, the raster lines 414a-414h are output in one burst to the memory 406, and then the next set of image blocks are converted and stored in the buffer 404. Thus, the memory 406 receives bursts of raster blocks, each representing a portion of the width of the image 402.

### Example System for Block to Burst Conversion

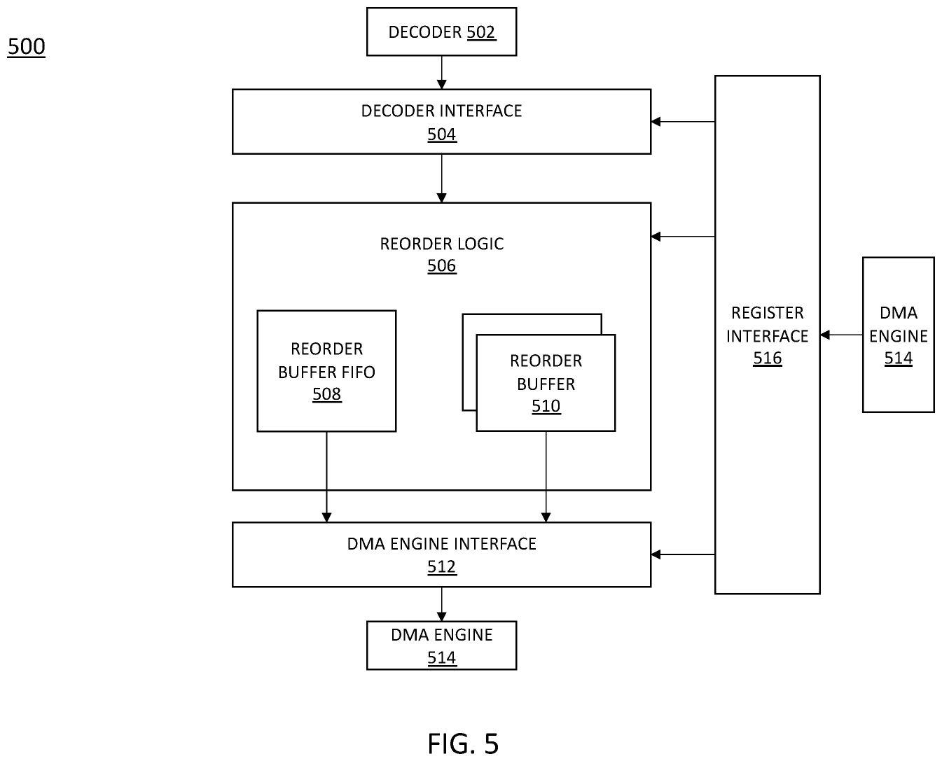

FIG. 5 is a block diagram illustrating a system 500 including reorder logic 506 for block to burst conversion, according to some examples of the present disclosure. The system 500 includes a decoder 502 for decoding encoded images. In some examples, the decoder 502 is a JPEG decoder and decodes encoded JPEG images. The encoded image is encoded using in image blocks, each block representing an n-by-m pixel block of the image. In various examples, an image is encoded using thousands of image blocks. The output from the decoder 502 is received at a decoder interface 504. In some examples, the decoder interface 504 receives raw image blocks. In one example, the decoder interface 504 receives raw JPEG image blocks. In some examples, the raw JPEG image blocks include 1-6 MCU of pixel data. In some examples, the decoder interface 504 is an AXI (Advanced extensible Interface) stream interface to the decoder 502. In some examples, the decoder interface 504 receives multiple image blocks from the decoder 502, where the multiple image blocks represent a portion of the width of the encoded image.

In some examples, the decoder interface 504 receives two stream inputs: a first input for frame data and a second input for pixel data. The frame data includes image width and image height. In some examples, a state machine is used to hold off reception of pixel data until frame data is received by the decoder interface 504. The state machine waits for frame data in a first state. When valid frame data is received, the state machine transitions to a second state and prepares logic for receiving pixel data. After one clock cycle in the second state, the state machine transitions to a third state and enables reception of pixel data. When the last pixel of image data is received, the state machine transitions to a fourth state and remains in the fourth state until the pixel data has been written to the direct memory access (DMA) engine.

The raw image blocks from the decoder interface 504 are output to reorder logic 506. The reorder logic 506 converts raw image blocks into raster blocks. In some examples, the reorder logic 506 performs block to burst conversion. In some examples, MCU formatted input is converted to raster block output format. The reorder logic 506 converts input signed pixels to unsigned pixels and writes unsigned pixels to reorder buffer memory 510 in the same order as the raster scan line. The reorder logic 506 includes a FIFO (first in first out) reorder buffer 508 and two reorder buffers 510. In some examples, the two reorder buffers 510 allow simultaneous ingress and egress operations. While one buffer 510 is receiving reorder logic 506 data (reading pixel data) and supporting ingress, the other buffer is outputting the converted data (writing pixel data) and supporting egress. In some examples, each of the reorder buffers 510 is 96×8 pixels (768 pixels).

In some examples, the reorder buffer 510 includes four memories. Pixels are striped across the four memories in raster scan line order. For instance, a first image pixel is written to memory0, a second image pixel is written to memory1, a third image pixel is written to memory2, and a fourth image pixel is written to memory3. A fifth image pixel is then written to memory0, a sixth image pixel is written to memory1, and so on.

In some examples, the reorder buffers 510 each support up to twelve image blocks. In some examples, for a JPEG image block, the reorder buffers 510 support a MCU size of 1, 3, 4, or 6 JPEG blocks. For a reorder buffer 510 size of 12 JPEG image blocks having 12-bit pixels, the DMA transfer size is 144 bytes. For a reorder buffer 510 size of 24 JPEG image blocks having 12-bit pixels, the DMA transfer size is 288 bytes.

The FIFO reorder buffer 508 can be used to pass buffer ready status and buffer size to the DMA Engine Interface 512. When one of the reorder buffers 510 is ready to output converted pixel data, the buffer identification and buffer size is written to the FIFO reorder buffer 508. In some examples, the reorder buffer 510 size can be between one and twelve blocks of data. In some examples, the reorder buffer 510 size is equivalent to twelve blocks of data, such that one to twelve blocks of data can be written to the reorder buffer 510. In some examples, the reorder buffer 510 size is twelve JPEG blocks, such that data written to the buffer can include one JPEG block, between one and twelve JPEG blocks, or twelve JPEG blocks. The write location for a pixel within buffer memory is calculated based on buffer address, row stride, row image offset (for each image color component), and pixel offset.

The reorder buffers 510 output raster block image data to a DMA engine interface 512. The raster block image data is a partial raster scan line for a set of raster scan lines. In one example, the raster block image data is a partial raster scan line for eight raster scan lines. The DMA engine interface 512 transfers each partial raster scan line from the reorder buffers 510 to the DMA engine 514, by providing an AXI stream interface to the DMA engine 514. In some examples, a different type of streaming interface is provided to the DMA engine. In some examples, the DMA engine 514 stores decoded image data in RAM, such as DRAM. In various examples, the DMA engine 514 knows the address (within the frame boundary) for where to write the burst requests received from the BBC block. In some examples, expected frame parameters are configured into the DMA data channel. The DMA channel can compute the addresses on the fly and use the addresses to issue AXI write burst requests.

In some examples, the block to burst conversion system 500 converts between one and twelve image blocks at a time. The block to burst conversion system 500 receives an input stream of raw encoded image blocks, and outputs a stream of raster blocks. In some examples, the block to burst conversion system 500 can be used with interleaved or non-interleaved input streams. In some examples, the block to burst conversion system 500 can be used with different subsampling formats, such as a 4:4:4 subsampling format, a 4:2:2 subsampling format, or a 4:2:0 subsampling format. In some examples, a 4:4:4 input stream has full color data, a 4:2:2 input stream has color information reduced by half, and a 4:2:0 input stream has further reduced color information. Additionally, the block to burst conversion system 500 can be used with monochrome input streams.

In various implementations, the block to burst conversion system 500 including the reorder logic 506 converts small portions of an image (e.g., twelve sequential image blocks) to raster block format, and outputs corresponding small rectangles of the image in raster blocks. The output raster blocks are then further processed to connect corresponding raster blocks and regenerate the full image. In particular, the DMA engine 514 is programmed to write data received from the block to burst conversion system reorder logic 506 into the correct memory locations for building the raster image. In some examples, the block to burst conversion reorder logic 506 output is a partial raster line for eight rows. For each raster block, there are eight DMA transfers—one transfer for each row. In some examples, the DMA engine 514 is programmed with a row stride, where the row stride is the memory allocated for each raster row. When a raster block is received, the row stride is used to determine where in memory each partial raster line is written.

According to various examples, the block to burst conversion system 500 includes a register interface 516, which provides the DMA engine 514 control and status access to the block to burst converter. In some examples, the register interface 516 is a configuration interface and provides information used during the block to burst conversion. In some examples, software programmable features of the block to burst converter system 500 are accessed through the register interface 516 and maintained by the DMA engine 514. Software programmable features can include pixel size and image format, for example.

The block to burst conversion system 500 is a single processing pipe configuration. In a single pipe configuration, an image is processed by one image processing pipe having one decoder, one reorder logic module, and one DMA engine. In some examples, a block to burst conversion system is a dual pipe configuration, and an image is processed by two image processing pipes, with each pipe processing half the image.

### Method for Block to Burst Conversion

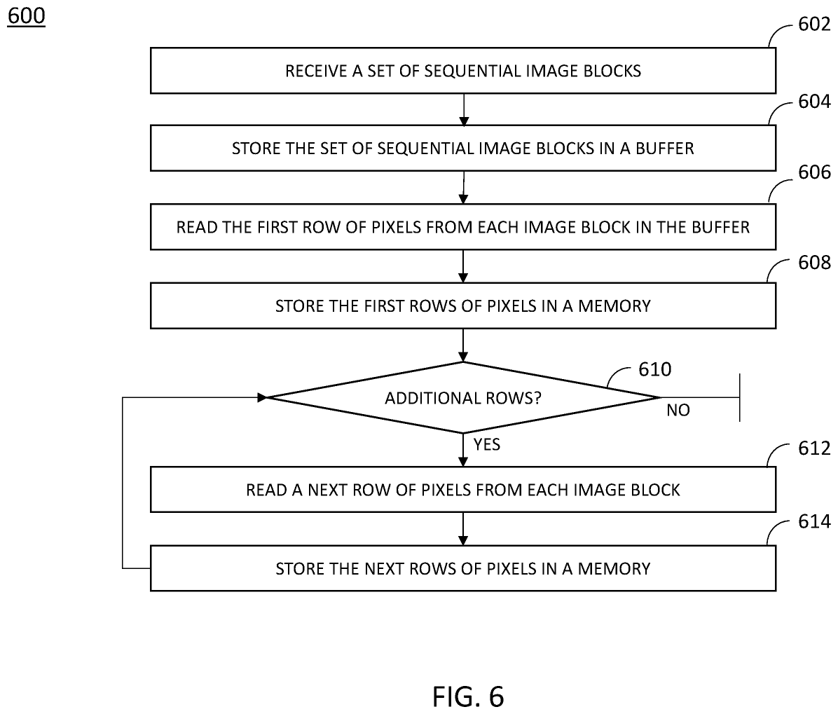

FIG. 6 is a flow chart 600 illustrating a method for block to burst conversion, according to some examples of the present disclosure. At step 602, a set of sequential image blocks is received. In one example, each image block is an 8 pixel-by-8 pixel square of image data. In one examples, each image block is a MCU. At step 604, the set of image blocks is stored in a buffer. The buffer can be the reorder buffer 510 discussed above with respect to FIG. 5. The buffer can be an SRAM buffer. From the reorder buffer, at step 606, a first row of pixels is read from each image block. At step 608, the first row of pixels from each image block is written to a memory in raster order. In various examples, The memory can be RAM, and the memory can be DRAM. In some examples, a DMA engine receives the first row of pixels from each image block at step 608, and stores the first rows of pixels in the memory.

At step 610, it is determined whether there are additional rows of pixels in the image blocks in the buffer. If there are additional rows of pixels, at step 612, a next row of pixels is read from each image block in the buffer. At step 614, the next row of pixels from each of the image blocks is stored in raster order in the memory. In some examples, a DMA engine receives the next rows of pixels from each image block at step 612, and stores the next rows of pixels in the memory at step 614. The method 600 then returns to step 610 and it is determined whether there are additional rows of pixels in the image blocks in the buffer. In some examples, each image block is an 8 pixel-by-8 pixel block, and thus, the method 600 repeats for eight rows of pixels. At step 610, if there are no additional rows of pixels, the method 600 ends. In various examples, the block to burst converter receives image data before decoding the image blocks, and the image data includes the number of scanlines (i.e., rows) in each image block. In some examples, when the buffer is full, the data in the buffer is sent to a DMA engine for writing to a DRAM memory. In some examples, when the end of an image is received, the data in the buffer is sent to a DMA engine for writing to a DRAM memory. In some examples, when the end of a row is reached, the data in the buffer is sent to the DMA engine for writing to a DRAM memory. In various examples, buffer contents are sent to the DMA engine one row at a time (i.e., in raster order) for writing to a DRAM memory.

### Example AV Management System

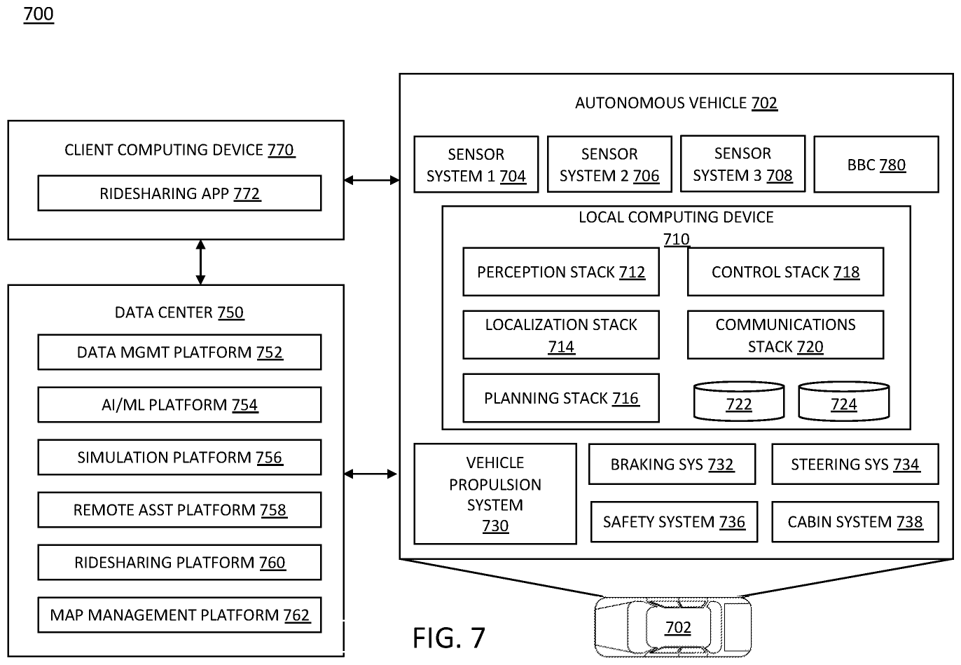

Turning now to FIG. 7, this figure illustrates an example of an AV management system 700. One of ordinary skill in the art will understand that, for the AV management system 700 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 700 includes an AV 702, a data center 750, and a client computing device 770. The AV 702, the data center 750, and the client computing device 770 can communicate with one another over one or more networks (not shown), such as a public network (e.g., the Internet, an Infrastructure as a Service (IaaS) network, a Platform as a Service (PaaS) network, a Software as a Service (Saas) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 702 can navigate about roadways without a human driver based on sensor signals generated by multiple sensor systems 704, 706, and 708. The sensor systems 704-708 can include different types of sensors and can be arranged about the AV 702. For instance, the sensor systems 704-708 can comprise IMUs, cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., GPS receivers), audio sensors (e.g., microphones, SONAR systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 704 can be a camera system, the sensor system 706 can be a LIDAR system, and the sensor system 708 can be a RADAR system. Other embodiments may include any other number and type of sensors.

The sensor systems 704-708 can include camera systems that generate image data. In some examples the camera systems generate encoded image data. The encoded image data can be decoded and received at a block to burst converter 780. The block to burst converter converts the decoded image data to raster order as discussed herein, and stores the decoded image data in raster block format in a vehicle memory. In some examples, the decoded image data is stored in the local computing device 710.

AV 702 can also include several mechanical systems that can be used to maneuver or operate AV 702. For instance, the mechanical systems can include vehicle propulsion system 730, braking system 732, steering system 734, safety system 736, and cabin system 738, among other systems. Vehicle propulsion system 730 can include an electric motor, an internal combustion engine, or both. The braking system 732 can include an engine brake, a wheel braking system (e.g., a disc braking system that utilizes brake pads), hydraulics, actuators, and/or any other suitable componentry configured to assist in decelerating AV 702. The steering system 734 can include suitable componentry configured to control the direction of movement of the AV 702 during navigation. Safety system 736 can include lights and signal indicators, a parking brake, airbags, and so forth. The cabin system 738 can include cabin temperature control systems, in-cabin entertainment systems, and so forth. In some embodiments, the AV 702 may not include human driver actuators (e.g., steering wheel, handbrake, foot brake pedal, foot accelerator pedal, turn signal lever, window wipers, etc.) for controlling the AV 702. Instead, the cabin system 738 can include one or more client interfaces (e.g., Graphical User Interfaces (GUIs), Voice User Interfaces (VUIs), etc.) for controlling certain aspects of the mechanical systems 730-738.

AV 702 can additionally include a local computing device 710 that is in communication with the sensor systems 704-708, the mechanical systems 730-738, the data center 750, and the client computing device 770, among other systems. The local computing device 710 can include one or more processors and memory, including instructions that can be executed by the one or more processors. The instructions can make up one or more software stacks or components responsible for controlling the AV 702; communicating with the data center 750, the client computing device 770, and other systems; receiving inputs from riders, passengers, and other entities within the AV's environment; logging metrics collected by the sensor systems 704-708; and so forth. In this example, the local computing device 710 includes a perception stack 712, a mapping and localization stack 714, a planning stack 716, a control stack 718, a communications stack 720, an High Definition (HD) geospatial database 722, and an AV operational database 724, among other stacks and systems.

Perception stack 712 can enable the AV 702 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 704-708, the mapping and localization stack 714, the HD geospatial database 722, other components of the AV, and other data sources (e.g., the data center 750, the client computing device 770, third-party data sources, etc.). The perception stack 712 can detect and classify objects and determine their current and predicted locations, speeds, directions, and the like. In addition, the perception stack 712 can determine the free space around the AV 702 (e.g., to maintain a safe distance from other objects, change lanes, park the AV, etc.). The perception stack 712 can also identify environmental uncertainties, such as where to look for moving objects, flag areas that may be obscured or blocked from view, and so forth.

Mapping and localization stack 714 can determine the AV's position and orientation (pose) using different methods from multiple systems (e.g., GPS, IMUs, cameras, LIDAR, RADAR, ultrasonic sensors, the HD geospatial database 722, etc.). For example, in some embodiments, the AV 702 can compare sensor data captured in real-time by the sensor systems 704-708 to data in the HD geospatial database 722 to determine its precise (e.g., accurate to the order of a few centimeters or less) position and orientation. The AV 702 can focus its search based on sensor data from one or more first sensor systems (e.g., GPS) by matching sensor data from one or more second sensor systems (e.g., LIDAR). If the mapping and localization information from one system is unavailable, the AV 702 can use mapping and localization information from a redundant system and/or from remote data sources.

The planning stack 716 can determine how to maneuver or operate the AV 702 safely and efficiently in its environment. For example, the planning stack 716 can receive the location, speed, and direction of the AV 702, geospatial data, data regarding objects sharing the road with the AV 702 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 702 from one point to another. The planning stack 716 can determine multiple sets of one or more mechanical operations that the AV 702 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 716 can select from multiple backup plans to carry out. For example, while preparing to change lanes to turn right at an intersection, another vehicle may aggressively cut into the destination lane, making the lane change unsafe. The planning stack 716 could have already determined an alternative plan for such an event, and upon its occurrence, help to direct the AV 702 to go around the block instead of blocking a current lane while waiting for an opening to change lanes.

The control stack 718 can manage the operation of the vehicle propulsion system 730, the braking system 732, the steering system 734, the safety system 736, and the cabin system 738. The control stack 718 can receive sensor signals from the sensor systems 704-708 as well as communicate with other stacks or components of the local computing device 710 or a remote system (e.g., the data center 750) to effectuate operation of the AV 702. For example, the control stack 718 can implement the final path or actions from the multiple paths or actions provided by the planning stack 716. This can involve turning the routes and decisions from the planning stack 716 into commands for the actuators that control the AV's steering, throttle, brake, and drive unit.

The communication stack 720 can transmit and receive signals between the various stacks and other components of the AV 702 and between the AV 702, the data center 750, the client computing device 770, and other remote systems. The communication stack 720 can enable the local computing device 710 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 720 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 722 can store HD maps and related data of the streets upon which the AV 702 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 724 can store raw AV data generated by the sensor systems 704-708 and other components of the AV 702 and/or data received by the AV 702 from remote systems (e.g., the data center 750, the client computing device 770, etc.). In some embodiments, the raw AV data can include HD LIDAR point cloud data, image or video data, RADAR data, GPS data, and other sensor data that the data center 750 can use for creating or updating AV geospatial data as discussed further below with respect to FIG. 5 and elsewhere in the present disclosure.

The data center 750 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 750 can include one or more computing devices remote to the local computing device 710 for managing a fleet of AVs and AV-related services. For example, in addition to managing the AV 702, the data center 750 may also support a ridesharing service, a delivery service, a remote/roadside assistance service, street services (e.g., street mapping, street patrol, street cleaning, street metering, parking reservation, etc.), and the like.

The data center 750 can send and receive various signals to and from the AV 702 and the client computing device 770. These signals can include sensor data captured by the sensor systems 704-708, roadside assistance requests, software updates, ridesharing pick-up and drop-off instructions, and so forth. In this example, the data center 750 includes one or more of a data management platform 752, an Artificial Intelligence/Machine Learning (AI/ML) platform 754, a simulation platform 756, a remote assistance platform 758, a ridesharing platform 760, and a map management platform 762, among other systems.

Data management platform 752 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 750 can access data stored by the data management platform 752 to provide their respective services.

The AI/ML platform 754 can provide the infrastructure for training and evaluating machine learning algorithms for operating the AV 702, the simulation platform 756, the remote assistance platform 758, the ridesharing platform 760, the map management platform 762, and other platforms and systems. Using the AI/ML platform 754, data scientists can prepare data sets from the data management platform 752; select, design, and train machine learning models; evaluate, refine, and deploy the models; maintain, monitor, and retrain the models; and so on.

The simulation platform 756 can enable testing and validation of the algorithms, machine learning models, neural networks, and other development efforts for the AV 702, the remote assistance platform 758, the ridesharing platform 760, the map management platform 762, and other platforms and systems. The simulation platform 756 can replicate a variety of driving environments and/or reproduce real-world scenarios from data captured by the AV 702, including rendering geospatial information and road infrastructure (e.g., streets, lanes, crosswalks, traffic lights, stop signs, etc.) obtained from the map management platform 762; modeling the behavior of other vehicles, bicycles, pedestrians, and other dynamic elements; simulating inclement weather conditions, different traffic scenarios; and so on.

The remote assistance platform 758 can generate and transmit instructions regarding the operation of the AV 702. For example, in response to an output of the AI/ML platform 754 or other system of the data center 750, the remote assistance platform 758 can prepare instructions for one or more stacks or other components of the AV 702.

The ridesharing platform 760 can interact with a customer of a ridesharing service via a ridesharing application 772 executing on the client computing device 770. The client computing device 770 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 772. The client computing device 770 can be a customer's mobile computing device or a computing device integrated with the AV 702 (e.g., the local computing device 710). The ridesharing platform 760 can receive requests to be picked up or dropped off from the ridesharing application 772 and dispatch the AV 702 for the trip.

Map management platform 762 can provide a set of tools for the manipulation and management of geographic and spatial (geospatial) and related attribute data. The data management platform 752 can receive LIDAR point cloud data, image data (e.g., still image, video, etc.), RADAR data, GPS data, and other sensor data (e.g., raw data) from one or more AVs 702, Unmanned Aerial Vehicles (UAVs), satellites, third-party mapping services, and other sources of geospatially referenced data. The raw data can be processed, and map management platform 762 can render base representations (e.g., tiles (2D), bounding volumes (3D), etc.) of the AV geospatial data to enable users to view, query, label, edit, and otherwise interact with the data. Map management platform 762 can manage workflows and tasks for operating on the AV geospatial data. Map management platform 762 can control access to the AV geospatial data, including granting or limiting access to the AV geospatial data based on user-based, role-based, group-based, task-based, and other attribute-based access control mechanisms. Map management platform 762 can provide version control for the AV geospatial data, such as to track specific changes that (human or machine) map editors have made to the data and to revert changes when necessary. Map management platform 762 can administer release management of the AV geospatial data, including distributing suitable iterations of the data to different users, computing devices, AVs, and other consumers of HD maps. Map management platform 762 can provide analytics regarding the AV geospatial data and related data, such as to generate insights relating to the throughput and quality of mapping tasks.

In some embodiments, the map viewing services of map management platform 762 can be modularized and deployed as part of one or more of the platforms and systems of the data center 750. For example, the AI/ML platform 754 may incorporate the map viewing services for visualizing the effectiveness of various object detection or object classification models, the simulation platform 756 may incorporate the map viewing services for recreating and visualizing certain driving scenarios, the remote assistance platform 758 may incorporate the map viewing services for replaying traffic incidents to facilitate and coordinate aid, the ridesharing platform 760 may incorporate the map viewing services into the client application 772 to enable passengers to view the AV 702 in transit en route to a pick-up or drop-off location, and so on.

### Example Processing System

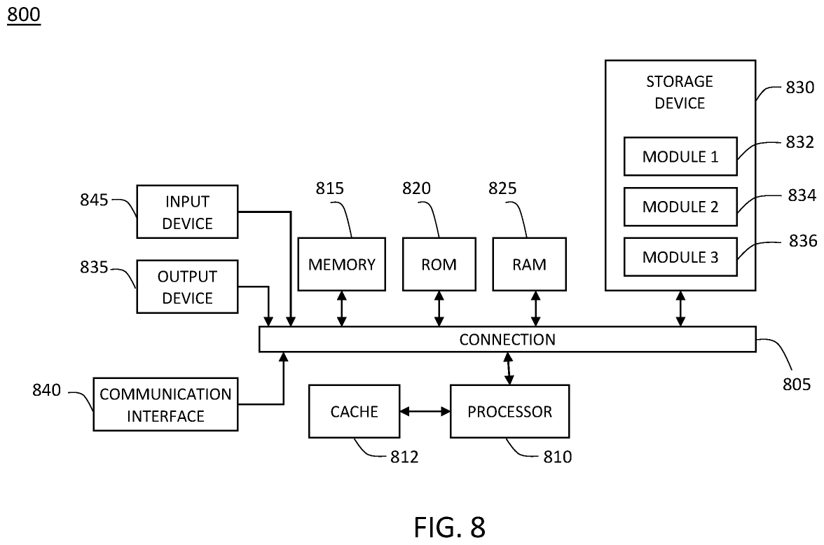

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random Access Memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more GNSS receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc (CD) Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Atatic RAM (SRAM), Dynamic RAM (DRAM), ROM, Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 provides a method for converting an image, comprising: reading a set of sequential image blocks, wherein the set of sequential image blocks represents a portion of a width of the image and a portion of a height of the image, and wherein each image block represents a plurality of rows of pixels of the image; converting the set of sequential image blocks to generate the plurality of rows of pixels including a first row of pixels and a second row of pixels; storing a set of converted sequential image blocks including the plurality of rows of pixels in a buffer on a chip; reading the first row of pixels from each converted sequential image block; storing the first row of pixels from each converted sequential image block in a random access memory RAM; reading the second row of pixels from each converted sequential image block; and storing the second row of each sequential image block of the set of image blocks in the RAM.

Example 2 provides a method, system, and/or vehicle according to one or more of the preceding and/or following examples, wherein reading a set of sequential image blocks comprises reading a set of sequential JPEG blocks.

Example 3 provides a method, system, and/or vehicle according to one or more of the preceding and/or following examples, wherein the RAM is a first RAM, wherein storing a set of decoded sequential image blocks in the buffer includes storing a set of decoded sequential image blocks in a static RAM, and wherein storing the first row of pixels in the first RAM includes storing the first row of pixels in a dynamic RAM.

Example 4 provides a method, system, and/or vehicle according to one or more of the preceding and/or following examples, wherein storing a set of decoded sequential image blocks in the buffer includes storing a set of decoded sequential image blocks in a cache and wherein the cache is one of: 64 kilobytes and less than 64 kilobytes.

Example 5 provides a method, system, and/or vehicle according to one or more of the preceding and/or following examples, wherein storing a set of decoded sequential image blocks in the buffer includes storing a set of decoded sequential image blocks in a cache and wherein the cache is one of: 128 kilobytes and less than 128 kilobytes.

Example 6 provides a method, system, and/or vehicle according to one or more of the preceding and/or following examples, wherein decoding the set of sequential encoded image blocks to generate the plurality of rows of pixels includes generating a plurality of scan lines of pixels.

Example 7 provides a method, system, and/or vehicle according to one or more of the preceding and/or following examples, wherein generating the plurality of scan lines of pixels includes generating eight scan lines of pixels.

Example 8 provides a method, system, and/or vehicle according to one or more of the preceding and/or following examples, wherein storing the first row of pixels from each decoded sequential image block includes storing the first row of pixels in raster order in the RAM, and wherein storing the second row of pixels from each decoded sequential image block includes storing the second row of pixels in raster order in the RAM.

Example 9 provides a method, system, and/or vehicle according to one or more of the preceding and/or following examples, further comprising allowing other processes to access the buffer.

Example 10 provides a method, system, and/or vehicle according to one or more of the preceding and/or following examples, further comprising generating rectangular blocks of decoded image data in raster block format in the RAM, and combining the rectangular blocks to reconstruct the image.

Example 11 provides a system for decoding an encoded image, comprising: a decoder to: receive a set of sequential encoded image blocks, wherein the set of sequential encoded image blocks represents a portion of a width of the encoded image and a portion of a height of the encoded image, and wherein each encoded image block represents a plurality of rows of pixels of the encoded image; decode the set of sequential encoded image blocks to generate the plurality of rows of pixels including a first row of pixels and a second row of pixels; a buffer to store a set of decoded sequential image blocks including the plurality of rows of pixels; and a random access memory (RAM) to: receive the first row of pixels from each decoded sequential image block in the buffer; store the first row of pixels from each decoded sequential image block; receive the second row of pixels from each decoded sequential image block in the buffer; and store the second row of pixels from each sequential image block.

Example 12 provides a method, system, and/or vehicle according to one or more of the preceding and/or following examples, wherein the RAM is a dynamic RAM (DRAM), and wherein the buffer is a SRAM (static RAM).

Example 13 provides a method, system, and/or vehicle according to one or more of the preceding and/or following examples, wherein the buffer includes a first reorder buffer and a second reorder buffer, wherein the set of decoded sequential image blocks is a first set of decoded sequential image blocks, and wherein the first reorder buffer outputs the first set of decoded sequential image blocks while the second reorder buffer receives a next set of decoded image blocks.

Example 14 provides a method, system, and/or vehicle according to one or more of the preceding and/or following examples, further comprising a cache including the first and second reorder buffers, wherein the cache is one of: 64 kilobytes and less than 64 kilobytes.

Example 15 provides a method, system, and/or vehicle according to one or more of the preceding and/or following examples, further comprising a cache including the first and second reorder buffers, wherein the cache is one of: 256 kilobytes and less than 256 kilobytes.

Example 16 provides a method, system, and/or vehicle according to one or more of the preceding and/or following examples, wherein the set of sequential encoded image blocks represents less than half the width of the encoded image.

Example 17 provides a method, system, and/or vehicle according to one or more of the preceding and/or following examples, wherein each encoded image block represents an image portion that is eight pixels wide and eight scan lines high.

Example 18 provides a method, system, and/or vehicle according to one or more of the preceding and/or following examples, wherein the system converts the sequential encoded image blocks to raster blocks, and wherein the RAM is to store the first and second rows of pixels in raster order.

Example 19 provides a vehicle for recording image data, comprising: a plurality of cameras to record image data, each camera saving the image data as encoded image blocks; a block to burst converter for decoding the image data, including: a decoder, wherein for each image, the decoder is to: receive a set of sequential encoded image blocks from the plurality of cameras representing a portion of a width of the encoded image and a portion of a length of the encoded image, wherein each encoded image block represents a plurality of rows of pixels of the encoded image; decode the set of sequential encoded image blocks to generate the plurality of rows of pixels including a first row of pixels and a second row of pixels; a buffer to store a set of decoded sequential image blocks including the plurality of rows of pixels; and a random access memory (RAM) to: receive the first row of pixels from each decoded sequential image block in the buffer; store the first row of pixels from each decoded sequential image block; receive the second row of pixels from each decoded sequential image block in the buffer; and store the second row of pixels from each sequential image block; and an onboard computer to store decoded images.

Example 20 provides a method, system, and/or vehicle according to one or more of the preceding and/or following examples, wherein the buffer includes a first reorder buffer and a second reorder buffer, wherein the set of decoded sequential image blocks is a first set of decoded sequential image blocks, and wherein the first reorder buffer outputs the first set of decoded sequential image blocks while the second reorder buffer receives a next set of decoded image blocks.

Example 21 provides a method, system, and/or vehicle according to one or more of the preceding and/or following examples, wherein the onboard computer further comprises a cache including the first and second reorder buffers, wherein the cache can be utilized by other processes while the decoder decodes the set of sequential encoded image blocks.

Example 22 provides a method, system, and/or vehicle according to one or more of the preceding and/or following examples, wherein the block to burst converter includes a plurality of block to burst converters, and wherein each of the plurality of cameras has a corresponding block to burst converter.

Example 23 provides a method, system, and/or vehicle according to one or more of the preceding and/or following examples, wherein the decoder is a first decoder and the buffer is a first buffer, wherein the first decoder and the first buffer comprise a first pipe for processing a first part of the image, and further comprising a second decoder and a second buffer, wherein the second decoder and the second buffer comprise a second pipe for processing a second part of the image.

Example 24 provides a method, system, and/or vehicle according to one or more of the preceding and/or following examples, wherein the system converts the sequential encoded image blocks to raster blocks, and wherein the RAM is to store the first and second rows of pixels in raster order.

Example 25 provides a method for converting an image, comprising: reading a set of sequential encoded image blocks, wherein the set of sequential encoded image blocks represents a portion of a width of the image and a portion of a height of the image, and wherein each encoded image block represents a plurality of rows of pixels of the image; decoding the set of sequential encoded image blocks to generate the plurality of rows of pixels including a first row of pixels and a second row of pixels; storing a set of decoded sequential image blocks including the plurality of rows of pixels in a buffer on a chip; reading the first row of pixels from each decoded sequential image block; storing the first row of pixels from each decoded sequential image block in a random access memory RAM; reading the second row of pixels from each decoded sequential image block; and storing the second row of each sequential image block of the set of image blocks in the RAM.

Example 26 provides a method a vehicle for recording image data, comprising: a plurality of cameras to record image data, each camera saving the image data as encoded image blocks; a decoder to decode the encoded image blocks and generate minimum coded unit (MCU) image blocks; a block to burst converter for converting the MCU image blocks, including: a converter, wherein for each image, the converter is to: receive a set of sequential MCU image blocks from image data from the plurality of cameras, wherein the sequential MCU image blocks represent a portion of a width of the image and a portion of a length of the image, wherein each MCU image block represents a plurality of rows of pixels of the image; convert the set of sequential MCU image blocks to generate the plurality of rows of pixels including a first row of pixels and a second row of pixels; a buffer to store a set of converted sequential image blocks including the plurality of rows of pixels; and a random access memory (RAM) to: receive the first row of pixels from each converted sequential image block in the buffer; store the first row of pixels from each converted sequential image block; receive the second row of pixels from each converted sequential image block in the buffer; and store the second row of pixels from each converted sequential image block; and an onboard computer to store converted images.

Example 27 includes a computer-readable medium for performing the methods of any of the examples 1-26.

Example 28 includes an apparatus comprising means for performing the method of any of the examples 1-27.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A method for converting an image, comprising:
reading a set of sequential image blocks representing a portion of a width of the image and a portion of a height of the image, wherein each image block represents a plurality of rows of pixels of the portion of the image;
converting the set of sequential image blocks to generate the plurality of rows of pixels including a first row of pixels and a second row of pixels;
storing a set of converted sequential image blocks including the plurality of rows of pixels in a buffer on a chip;
reading the first row of pixels from each converted sequential image block from the buffer;
storing the first row of pixels from each converted sequential image block in a random access memory (RAM);
reading the second row of pixels from each converted sequential image block from the buffer; and
storing the second row of each sequential image block of the set of image blocks in the RAM.

2. The method of claim 1, wherein reading a set of sequential image blocks comprises reading a set of minimum coded unit (MCU) blocks of pixel data representing sequential JPEG blocks.

3. The method of claim 1, wherein the RAM is a first RAM, wherein storing the set of converted sequential image blocks in the buffer includes storing the set of converted sequential image blocks in a static RAM, and wherein storing the first row of pixels in the first RAM includes storing the first row of pixels in a dynamic RAM in raster block format.

4. The method of claim 1, wherein storing the set of converted sequential image blocks in the buffer includes storing the set of converted sequential image blocks in a cache and wherein the cache is one of: 64 kilobytes and less than 64 kilobytes.

5. The method of claim 1, wherein converting the set of sequential image blocks to generate the plurality of rows of pixels includes generating a plurality of scan lines of pixels.

6. The method of claim 5, wherein generating the plurality of scan lines of pixels includes generating eight scan lines of pixels.

7. The method of claim 1, wherein storing the first row of pixels from each converted sequential image block includes storing the first row of pixels in raster order in the RAM, and wherein storing the second row of pixels from each converted sequential image block includes storing the second row of pixels in raster order in the RAM.

8. A system for converting an image, comprising:
a converter to:
receive a set of sequential image blocks,
wherein the set of sequential encoded image blocks represents a portion of a width of the image and a portion of a height of the image, and
wherein each image block represents a plurality of rows of pixels of the image;
convert the set of sequential image blocks to generate the plurality of rows of pixels including a first row of pixels and a second row of pixels;
a buffer to store a set of converted sequential image blocks including the plurality of rows of pixels; and
a random access memory (RAM) to:
receive the first row of pixels from each converted sequential image block in the buffer;
store the first row of pixels from each converted sequential image block;
receive the second row of pixels from each converted sequential image block in the buffer; and
store the second row of pixels from each sequential image block.

9. The system of claim 8, wherein the RAM is a dynamic RAM (DRAM), and wherein the buffer is a SRAM (static RAM).

10. The system of claim 8, wherein the buffer includes a first reorder buffer and a second reorder buffer,
wherein the set of converted sequential image blocks is a first set of converted sequential image blocks, and
wherein the first reorder buffer outputs the first set of converted sequential image blocks while the second reorder buffer receives a next set of converted image blocks.

11. The system of claim 10, further comprising a cache including the first and second reorder buffers, wherein the cache is one of: 64 kilobytes and less than 64 kilobytes.

12. The system of claim 8, wherein the set of sequential converted image blocks represents less than half the width of the image.

13. The system of claim 12, wherein each converted image block represents an image portion that is 8 pixels wide and 8 scan lines high.

14. The system of claim 8, wherein the converter converts the sequential image blocks to raster blocks, and wherein the RAM is to store the first and second rows of pixels in raster order.

15. A vehicle for recording image data, comprising:
a plurality of cameras to record image data, each camera saving the image data as encoded image blocks;
a decoder to decode the encoded image blocks and generate minimum coded unit (MCU) image blocks;
a block to burst converter for converting the MCU image blocks, including:
a converter, wherein for each image, the converter is to:
receive a set of sequential MCU image blocks from image data from the plurality of cameras, wherein the sequential MCU image blocks represent a portion of a width of the image and a portion of a length of the image, wherein each MCU image block represents a plurality of rows of pixels of the image;
convert the set of sequential MCU image blocks to generate the plurality of rows of pixels including a first row of pixels and a second row of pixels;
a buffer to store a set of converted sequential image blocks including the plurality of rows of pixels; and
a random access memory (RAM) to:
receive the first row of pixels from each converted sequential image block in the buffer;
store the first row of pixels from each converted sequential image block;
receive the second row of pixels from each converted sequential image block in the buffer; and
store the second row of pixels from each converted sequential image block; and
an onboard computer to store converted images.

16. The vehicle of claim 15, wherein the buffer includes a first reorder buffer and a second reorder buffer,
wherein the set of converted sequential image blocks is a first set of converted sequential image blocks, and
wherein the first reorder buffer outputs the first set of converted sequential image blocks while the second reorder buffer receives a next set of converted image blocks.

17. The vehicle of claim 16, wherein the onboard computer further comprises a cache including the first and second reorder buffers, wherein the cache can be utilized by other processes while the converter converts the set of sequential MCU image blocks.

18. The vehicle of claim 15, wherein the block to burst converter includes a plurality of block to burst converters, and wherein each of the plurality of cameras has a corresponding block to burst converter.

19. The vehicle of claim 15, wherein the converter is a first converter and the buffer is a first buffer, wherein the first converter and the first buffer comprise a first pipe for processing a first part of the image, and further comprising a second converter and a second buffer, wherein the second converter and the second buffer comprise a second pipe for processing a second part of the image.

20. The vehicle of claim 15, wherein the system converts the sequential encoded image blocks to raster blocks, and wherein the RAM is to store the first and second rows of pixels in raster order.
